(19) United States
(12) Patent Application Publication
(10) Pub. No.: US 2006/0256390 A1
(43) Pub. Date: Nov. 16, 2006

(54) Capturing and reporting the amount of effort expended in working on a document

(75) Inventors: Dean Anthony Racovolis, Redmond, WA (US); Steven Harris Mitchell, Tumwater, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/130,819

(22) Filed: May 16, 2005

(51) Int. Cl. H04N 1/00

(52) U.S. Cl. 358/305

(57) ABSTRACT

Described herein are systems and methods for capturing an amount of effort expended in working on a document. One or more periods of time during which a document is an active document within an active window on a user interface may be determined. Further, one or more periods of time during which a window in which the document is displayed is a most forward window may be determined. For one or more determined periods of time, one or more temporal intervals may be determined during which it is inferred that effort was not being expended on the document. A total amount of time expended in working on the document may be determined based, at least in part, on the determined one or more periods and the determined one or more temporal intervals. An effort report may be generated including an indication corresponding to the determined total amount of time expended.

### BACKGROUND

It is often desirable to know the amount of effort expended in working on a (i.e., creating and/or editing content of) document, and this effort is often measured in units of time. For example, lawyers, contractors, consultants and other service providers often charge an amount to clients for preparing a document (e.g., a contract), this amount based largely or solely on the time spent in preparing the document. Further, employers may measure performance of an employee (mentally or in an actual performance review) based at least in part on the time the employee spends preparing documents.

Some software applications track information regarding the amount of effort expanded working on a document, which then can be displayed by users. For example, FIG. 1 is a screenshot of statistics panel 100 provided by versions of Microsoft® Word, available from Microsoft Corporation of Redmond, Wash. Panel 100 typically is accessed by selecting “Properties” from with the File menu of Microsoft® Word, resulting in the display of properties window 102, and then selecting the statistics panel 100 (e.g., using the mouse to select the tab labeled “Statistics” or using the keyboard).

Statistics panel 100 includes an editing time field 104, which purports to specify the cumulative time spent working on the document. However, the value displayed in field 104 is merely a estimate. This value is determined by recording the cumulative time the document is open (i.e., in use by a user). That is, a timer starts each time the document is opened by a user, and stops each time the document is closed. This technique does not account for the fact that users often leave documents open even when they are not actually working on them, sometimes for several hours or even days. For example, in field 104 a value of “135 minutes” is displayed. However, the document may have been initially opened and worked on by a user for ten minutes, and then left open for another one hundred twenty-five minutes while the user worked on something else. Thus, the value displayed in editing tine field 104 can be grossly inaccurate.

Further statistics window 106 displays multiple statistics with respect to a document, including number of pages, number of paragraphs, number of lines, number of words, number of characters and number of characters including spaces. However, none of these values reflect how much of the content of the document was originally created in the document and how much of the content was actually copied from another source. For example, of the 4,256 words included in the document (as reflected in field 108), many may have been copied from another document. Thus, although the statistics presented in statistics field 106 may provide an accurate representation of the volume of the content of the document, these statistics do not necessarily reflect how much effort was involved in working on the document.

Described herein are systems and methods for capturing an amount of effort expended in working on a document and generating a report indicative of this amount of effort. The generator report may be displayed to users on a user interface display and/or printed on paper.

In an embodiment of the invention, an amount of effort expended in working on a document is captured. One or more periods of time are determined during which a window in which the document is displayed is an active window on a user interface display and the document is an active document in the active window. A total amount of time expended in working on the document is determined based, at least in part, on the determined one or more periods.

In an aspect of this embodiment, for the one or more periods of time, one or more temporal intervals are determined during which it is inferred that effort was not being expended on the document. Determining the total amount of time is based, at least in part, on the determined one or more periods.

In another aspect of this embodiment, an effort report is generated including an indication corresponding to the determined total amount of time expended.

In another aspect of this embodiment, the portions of content originally created in the document and the portions not originally created are determined. Generating the effort report includes including in the effort report an indication corresponding to an amount of the content that was originally created in the document and/or an indication corresponding to an amount of the content that was not originally created in the document.

In yet another aspect of this embodiment, a number of keystrokes made in working on the document is recorded. Generating the effort report includes including in the effort report an indication corresponding to the number of keystrokes.

In another aspect of this embodiment, a number of copies of the document printed is recorded. Generating the effort report includes including in the effort report an indication corresponding to the number of copies.

In another aspect of this embodiment, determining the one or more period of times includes determining, for each of a plurality of users, one or more periods of time during which a window in which the document is displayed is an active window and the document is the active document. For each user, a total amount of time expended in working on the document by the user is determined, based, at least in part, on the one or more periods determined for the user.

In another embodiment of the invention, a computer-readable medium is provided that stores computer-readable signals defining instructions that, as a result of being executed by a computer, instruct the computer to perform the embodiment of the invention described in the preceding paragraphs and/or one or more aspects thereof described in the preceding paragraph.

In another embodiment of the invention, a system is provided for capturing an amount of effort expended in working on a document. The system includes an effort capturing module to determine one or more periods of time during which a window in which the document is displayed is an active window on a user interface display and the document is the active document in an active window, and to determine a total amount of time expended in working on the document based, at least in part, on the determined one or more periods.

In an aspect of this embodiment, the effort capturing module is further operative to determine, for the one or more periods of time, one or more temporal intervals during which it is inferred that effort was not being expended on the document, and to determine the total amount of time expended based, at least in part, on the determined one or more periods.

In another aspect of this embodiment, the system includes a report generating module to generate an effort report including an indication corresponding to the determined total amount of time expended.

In another aspect of this embodiment, the effort capturing module is operative to determine which portions of content were originally created in the document and which portions were not originally created. Further, the report generating module is operative to include in the effort report an indication corresponding to an amount of the content that was originally created in the document and/or an indication corresponding to an amount of the content that was not originally created in the document.

In yet another aspect of this embodiment, the effort capturing module is operative to record a number of keystrokes made in working on the document, and the report generating module is operative to include in the effort report an indication corresponding to the number of keystrokes.

In another aspect of this embodiment, the effort capturing module is operative to record a number of printed copies of the document, and the report generating module is operative to include in the effort report an indication corresponding to the number of copies.

In another aspect of this embodiment, the effort capturing module is operative to determine, for each of a plurality of users, one or more periods of time during which a window in which the document is displayed is an active window for the user on a user interface display and the document is an active document in the active window. Further, the report generating module is operative to determine, for each user, a total amount of time expended in working on the document by the user, based, at least in part, on the one or more periods determined for the user.

In another embodiment of the invention, an amount of effort expended in working on a document is captured. One or more periods of time are determined during which a window in which the document is displayed is a most forward window on a user interface display and the document is an active document in the most forward window. A total amount of time expended in working on the document is determined based, at least in part, on the determined one or more periods.

In an aspect of this embodiment, for the one or more periods of time, one or more temporal intervals are determined during which it is inferred that effort was not being expended on the document. Determining the total amount of time is based, at least in part, on the determined one or more periods.

In another aspect of this embodiment, an effort report is generated including an indication corresponding to the determined total amount of time expended.

In another aspect of this embodiment, the portions of content originally created in the document and the portions not originally created are determined. Generating the effort report includes including in the effort report an indication corresponding to an amount of the content that was originally created in the document and/or an indication corresponding to an amount of the content that was not originally created in the document.

In yet another aspect of this embodiment, a number of keystrokes made in working on the document is recorded. Generating the effort report includes including in the effort report an indication corresponding to the number of keystrokes.

In another aspect of this embodiment, a number of copies of the document printed is recorded. Generating the effort report includes including in the effort report an indication corresponding to the number of copies.

In another aspect of this embodiment, determining the one or more period of times includes determining, for each of a plurality of users, one or more periods of time during which a window in which the document is displayed is a most forward window and the document is the active document in the most forward window. For each user, a total amount of time expended in working on the document by the user is determined, based, at least in part, on the one or more periods determined for the user.

In another embodiment of the invention, a computer-readable medium is provided that stores computer-readable signals defining instructions that, as a result of being executed by a computer, instruct the computer to perform the embodiment of the invention described in the preceding paragraphs and/or one or more aspects thereof described in the preceding paragraphs.

In yet another embodiment of the invention, a system is provided for performing the method described in the preceding paragraphs and/or one or more aspects thereof.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a screen shot of a statistics panel provided by Microsoft® Word;

FIG. 2 is a flow chart illustrating an example of a method of capturing and reporting an amount of effort expended in working on a document, according to some embodiments of the invention;

FIG. 3 is a diagram illustrating an example of an effort report reflecting an amount of effort expended in working on a document, according to some embodiment of the invention;

FIG. 4 is a block diagram illustrating an example of a system for capturing and reporting an amount of effort extended in working on a document, according to some embodiments of the invention;

FIG. 5 is a block diagram illustrating an example of a computer system on which some embodiments of the invention may be implemented; and

FIG. 6 is a block diagram illustrating an example of a storage system that may be used as part of the computer system to implement some embodiments of the invention.

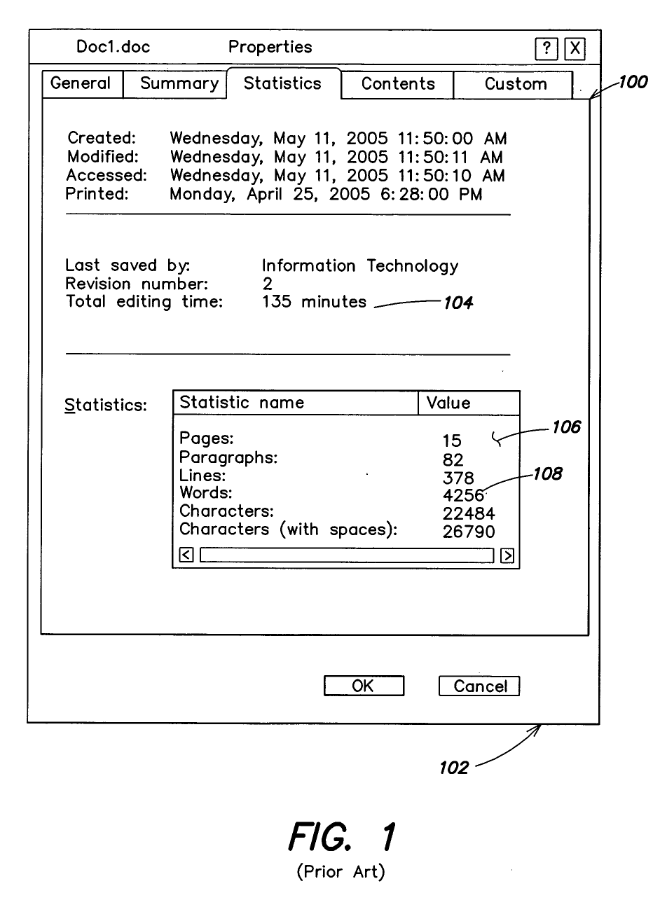

### DETAILED DESCRIPTION

Although embodiments described herein are described in relation to Microsoft® Word, it should be appreciated that the invention is not so limited. Embodiments of the invention may be implemented using other applications and other types of applications, including other applications of the Microsoft® Office suite of applications available from Microsoft Corporation.

The function and advantage of embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

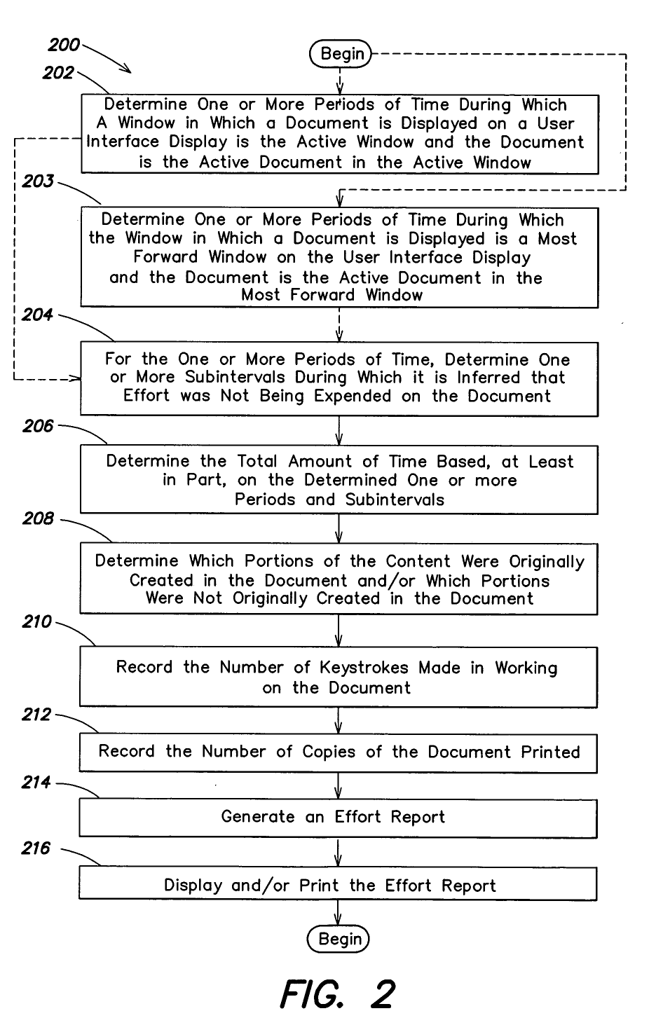

FIG. 2 is a flow chart illustrating an example of a method 200 of capturing and reporting an amount of effort expended in working on a document, according to some embodiments of the invention. Method 200 is merely an illustrative embodiment of a method of capturing and reporting an amount of effort expended in working on a document, and is not intended on limiting the scope of the invention. Any of numerous other implementations of such a method, for example, variations of method 200, are possible and are intended to fall within scope of the invention.

In Act 202, one or more periods of time may be determined during which a window in which a document is displayed on a user interface display is the active window and the document is the active document in the active window. As used herein, a “window” is a bounded display area of a user interface display in which information is displayed to a user, and in which a user may be enabled to enter, modify or delete information. As used herein, the “active window” of a user interface display is the window within which the user is currently (or was most recently) working. It is visually presented in the foreground of a GUI display, in front of other application windows (if present), and typically includes a cursor or other indicator residing within it. An active window is often referred to as the window that is “in focus.” Further, many software applications today such as, for example, Microsoft® Word, provide the ability to keep multiple documents open concurrently in the application. As used herein, a “active document” is the document visually presented in the foreground of the active window, in front of the other documents, and typically includes a cursor or other indicator residing in the active document. That is, the active document is the document that is “in focus” and/or the document in which the user is currently working.

As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display”, respectively.

Act 202 may include using the application programming interface (API) provided by the operating system (through which method 200 is being implemented) to monitor the status of the application window in which the document is being worked on by a user. The operating system may be any of a variety of operating systems such as, for example, any of those set forth below. As used herein, an “application programming interface” or “API” is a set of one or more computer-readable instructions that provide access to one or more other sets of computer-readable instructions that define functions, so that such functions can be configured to execute on a computer in conjunction an application program. An API may be considered the “glue” between application programs and a particular computer environment or platform (e.g., any of those described below) and may enable a programmer to program applications to run on one or more particular computer platforms or in one or more particular computer environments.

Act 202 may include starting a timer each time it is determined that the document is the active document and the window in which the document is displayed is the active window. This timer may continue to count until it is detected that the window in which the document is displayed is no longer the active window and/or the document is no longer the active document in the window.

In Act 204, for the one or more periods of time, one or more sub-intervals may be determined during which it is inferred that effort was not being expended on the document. That is, even though the document may be the active document in the active window, at any given time effort may not be expended on the document. For example, a user may open a document and work on it, such that the document is the active document in the active window, but then not work on the document or any other application on the computer for stretches of time. Act 204 may employ one or more techniques for inferring these stretches of time. For example, when the document is the active document and is in the active window, a second timer may commence counting if a predefined amount of time has passed since a last user event has been detected. User actions may include any of a variety of user actions such as a keystrokes, a mouse event (e.g., a hover event, a left-click event, a right-click event, a double-click, a click-and-drag, etc.), a combination of a mouse event and a keyboard event, voice input, other user events, or any suitable combination of the foregoing. This other timer may continue to count until a next user event is detected. The amount of time that must pass before this timer starts counting may be any of a variety of amounts of time, and may be user-definable.

For example, it may be considered that a is working on a document when the reader is reading (i.e., reviewing) the document. Accordingly, the amount of time that must pass before this timer starts counting may be set at a value deemed indicative of a reasonable amount of time for a user to read what is presented on the screen before having to use the mouse, keyboard, voice input or other user event to scroll down further in the document. For example, the amount of time may be set at 20 or 30 seconds. In other embodiments, it may be considered that reading a document is not considered working on the document, such that the threshold amount of time is set to a relatively lower value such as, for example, 5 or 10 seconds. In yet other embodiments, a more conservative approach may be taken, where the threshold amount of time is a higher value such as, for example, greater than 30 seconds, even up to several minutes.

In Act 206, the total amount of time during which effort was expended on the document may be determined based, at least in part, on the one or more periods and one or more sub-intervals determined in Acts 202 and 204, respectively. For example, Act 206 may include adding the one or more periods determined in 202 and then subtracting the one or more sub-intervals determined in Act 204.

In some embodiments of the invention, as an alternative to performing Act 202, one or more periods of time during which the window is a most forward window (i.e., not overlapped by a portion of any other window) and during which the document is the active document in the most forward window may be determined in Act 203, for example, by using the operating system API to monitor the window. These one or more periods may be used to determine the total amount of time effort was exerted working on the document. In such embodiments, the one or more sub-intervals in Act 204 may be determined for the one or more periods of time during which the window is a most forward window and the document is the active document in the most forward window. In such embodiments, the total amount of time may be determined by subtracting the cumulative time of the one or more periods of time during which it is inferred that the effort was not being expended on the document from the cumulative amount of time of the one or periods determined in Act 203.

In contrast to an active window, a most forward window is not necessarily a window in which a cursor or other indicator resides in the active window and/or that is the in-focus window in which the user is currently working. For example, some operating systems (e.g., certain operating systems available from Microsoft Corporation, described below) enable a user to use two monitors simultaneously. In such an embodiment, a user may display a fully-maximized window on one monitor and a fully-maximized window on the monitor. Both windows may be most-forward windows on the user interface display, however, only one of these windows may be the active window at any given time.

In Act 208, it may determined which portions of the content of the document are originally created in the document itself and/or which portions are not originally created in the document. Even though the document itself may be new, at least some, if not most, of the content may not be original. For example, the creation and/or modifying of document often involves working from a template or form, such that the final document includes the imported content of the form or template and the added original contents.

Act 208 may include keeping track of (i.e., recording) portions of the document that are copied into the document (or duplicated within the document itself) and keeping track of which content within the portion is subsequently changed. For example, in some embodiments, Act 208 may include determining which content was copied in from a clipboard as opposed from being typed or voice input into the document. The “portions” of 208 may be any of a variety of portions such as, for example, sections of the document, paragraphs, sentences, words, characters, other portions, or any suitable combination of the foregoing. For example, if the portions are words, then Act 208 may include recording when one or more words are copied into the document and subsequently keeping track of when one or more of these words are deleted or changed. If a word is copied in and then deleted or changed, the count of the words not originally created may be decreased. A similar technique may be employed for other types of portions of content.

In Act 210, a number of keystrokes may (i.e., entered by a user) in working on the document may be recorded. The number of keystrokes may be indicative of how much effort was expended in working on document, an also may serve to indicate the efficiency of one or more individuals in working on the document. For example, if the number of keystrokes is relatively high in comparison to the original content created for the document, it may ascertained that the one or more users were inefficient in working on the document. Conversely, if the number of keystrokes is relatively low in comparison to the original content, it may be deemed that the one or more users that worked on the document were efficient.

In Act 212, the number of copies of the document printed (e.g., during the time in which the document was being worked on) may be recorded. This number may be indicative of how much effort was spent by one or more persons in reviewing paper copies of the document.

Method 200 may include recording and determining several other pieces of information indicative of an amount of effort expended working on a document, other than those illustrated in FIG. 2. For example, method 200 may include recording the total number of comments and/or bookmarks created within the document, and/or the amount of time consumed entering and/or modifying such comments and/or bookmarks. Other information may be recorded and/or determined.

Further, it should be appreciated that each piece of information described herein as being recorded and/or determined as part of method 200 may be recorded and or determined for two or more persons individually. That is, method 200 may include capturing an amount of effort expended in working on a document by each of a plurality of persons. Thus, each of Acts 202-212 and other acts of method 200 may be performed separately for each person.

In Act 214, an effort report may be generated based on information determined and/or recorded as part of method 200. This report may reflect an amount of effort expended in working on a document for each person that worked on the document and/or cumulatively for all persons that worked on the document. The generated report may include an indication corresponding to each piece of information recorded and/or determined. Each indication may be the actual value determined or recorded or may be a value or other indicator derived from the actual piece of information recorded or determined.

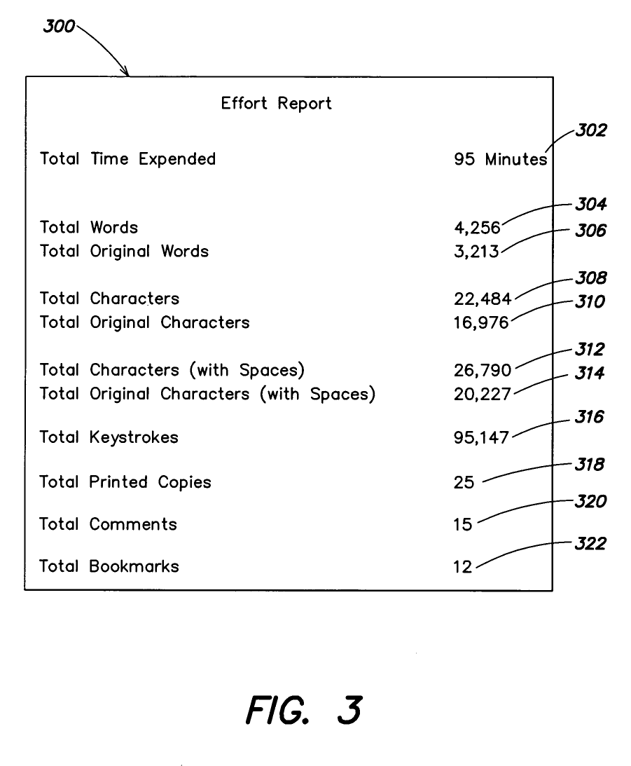

In Act 216, the effort report may be displayed and/or printed. The displayed and/or printed report may display any of the information determined or recorded in method 200 and/or other information, for example, any information shown in effort report 300 described below in relation to FIG. 3.

FIG. 3 is a diagram illustrating an example of an effort report 300 reflecting an amount of effort expended in working on a document, according to some embodiment of the invention. Report 300 is merely an illustrative embodiment of a report illustrating an amount of effort expended in working on a document, and is not intended to limit the scope of the invention. Any of numerous other implementations of such a report, for example, variations of report 300, are possible and are intended to fall within the scope of the invention. For example, effort report may be broken down based on any of a variety of criteria such as, for example, individual persons, groups of persons, department, during a particular temporal periods such as days, weeks, months or years, or other criteria. In fact, any of the information determined or recorded as part of Act 200 described above can be determined and/or recorded for any of these criteria.

Effort report 300 may include any of: time expended field 302; word field 304; original words field 306; characters field 308; original characters field 310; characters-with-spaces field 312; original characters-with-spaces field 314; keystrokes field 316; printed copies field 318; comments field 320; bookmarks field 322; other fields; or any suitable combination of the foregoing.

Time expended field 302 may be indicative of a total amount of time expended in working on the document, and may determined as described above in relation to Act 206. Words field 304 may reflect the total number of words in the document, whereas original words field 306 may hold a value indicative of the total number of words originally-created in the document. This total number of original words may be determined as described above in relation to Act 208.

Characters field 308 may hold a value of the total number of characters in the document, where as original characters field 310 may hold a value indicative of a total number of characters originally-created in the document. Field 310 may hold a value indicative of a value determined in accordance with Act 208 of method 200.

Characters-with-spaces field 312 may hold a value indicative of the total number of characters (including spaces) in the document, whereas original characters-with-spaces field 314 may hold a value indicative of characters (including spaces) originally-created in the document. The value in field 314 may be indicative of a total number of characters determined as described above in relation to Act 208 of method 200.

Keystrokes field 316 may hold a value indicative of a total number of keystrokes made while working on the document which may have been recorded as part of Act 210. Printed copy field 318 may hold a value indicative of a total number of copies of the document printed (e.g., while the document was being worked on), and may be determined as part of Act 212 described above and in relation to method 200.

Comments field 320 and bookmarks field 322 may hold values indicative of the total number of comments and bookmarks, respectively, created as part of working on the document, and may have been determined as part of method 200.

Method 200 may include additional acts. Further, the order of the acts performed as part of method 200 is not limited to the order illustrated in FIG. 2, as the acts may be performed in other orders and/or one or more of the acts may be performed in parallel, at least partially. For example, any of Acts 202-212 may be performed in parallel, at least partially, and at least part of each of these acts may be performed before or after at least part of the performance of each other act.

Method 200, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 600 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 200, 500 and 600 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

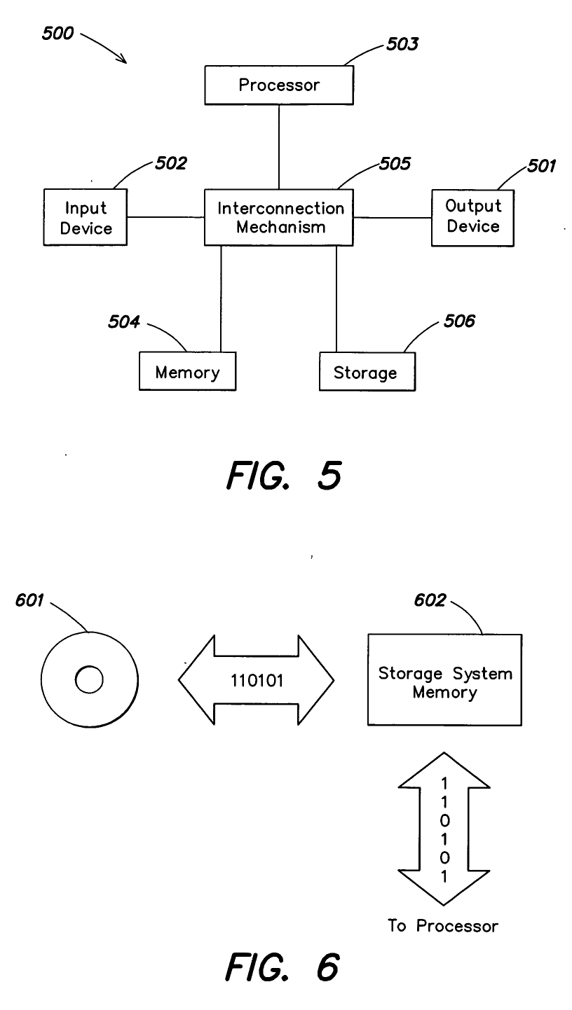

It should be appreciated that any single component or collection of multiple components of a computer system, for example, the computer system described in relation to FIGS. 5 and 6, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

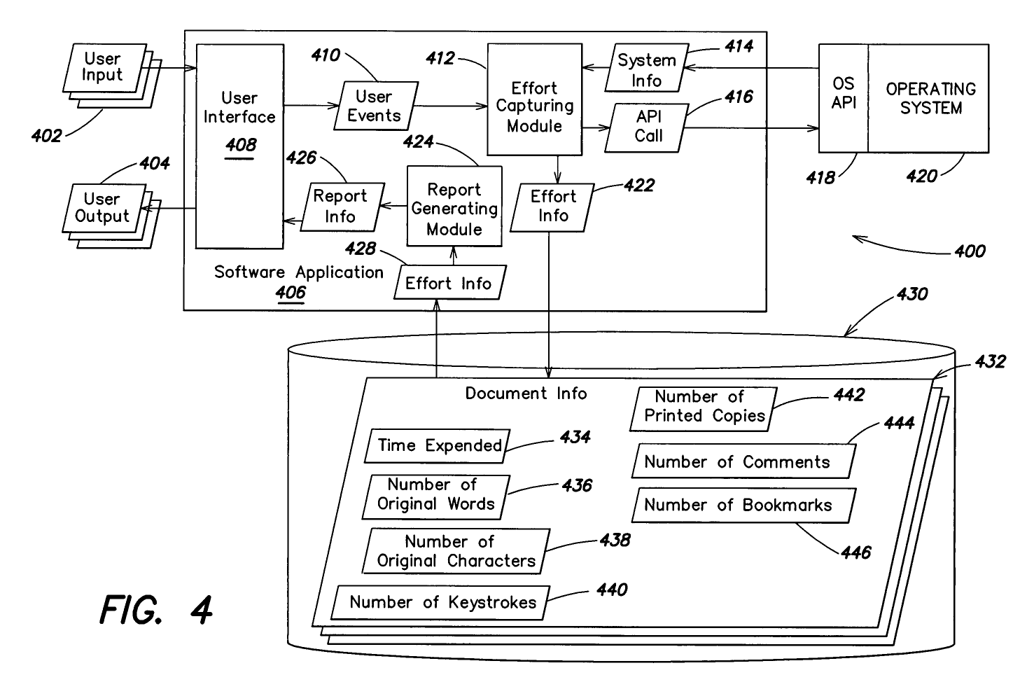

FIG. 4 is a block diagram illustrating an example of a system 400 for capturing and reporting an amount of effort expended in working on a document, according to some embodiments of the invention. System 400 is merely an illustrative embodiment of a system for capturing and reporting an amount of effort expended in working on a document, and is not intended to limit the scope of the invention. Any of numerous other implementations of such a method, for example, variations of system 400, are possible and are intended to fall within the scope of the invention.

System 400 may include any of: software application 400; operating system (OS) API 418; OS 420; data source 430; other components; or any suitable combination of the foregoing. Software application 406 may include any of: user interface configured to receive user input 402 and output user output 404; effort capturing module 412; report generating module 424; other components; and any suitable combination of the foregoing.

Effort capturing module 412 may be configured to determine and/or record one or more pieces of information indicative of an amount of effort expended working on a document such as, for example, any of the pieces of information determined and/or recorded as part of method 200. To capture this information, effort capturing module 412 may be configured to exchange communications with user interface 408, including receiving communications including user events 410 from user interface 408. Further, module 412 may be configured to exchange communications with the operating system API 418, including invoking API calls 416 to the API 418 and receiving one or more pieces of system info 414 from API 418. User events 410 and system info 414 together may include any of the pieces of information determined or recorded as part of method 200. Further, such pieces of information may be derived from system info 414 and/or user events 410.

Effort capturing module 412 may be configured to record such effort information 422 in data source 430, for example, as part of document 432. The effort information included in document information 432 may include any of: time expended information 434; number of original words information 436; number of original characters information 438; number of key strokes information 440; numbers of printed copies 442; number of comments 444; number of bookmarks 446; any information recorded and/or determined as part of method 200, other information, or any suitable combination of the foregoing.

Report generating module 424 may be configured to retrieve effort information 428 from data source 430, for example, from within document information 432.

Report generating module may be configured to generate an effort report from the effort information 428, for example, as described above in relation to Act 214 of method 200. Further, module 424 may be configured to communicate the report information 426 to user interface 408 so that the report information 426 may be included in one or more user outputs 404, such that the report information is displayed and/or printed as part of an effort report, for example, as described above in relation to Act 216.

System 400 and components thereof, may be implemented using any of a variety of technologies, including software (e.g., C, C#, C++, Java, J# or a combination thereof), hardware (e.g., one or more application-specific integrated circuits), firmware (e.g., electrically-programmed memory) or any combination thereof. One or more of the components of system 400 may reside on a single device (e.g., a computer), or one or more components may reside on separate, discrete devices. Further, each component may be distributed across multiple devices, and one or more of the devices may be interconnected.

Further, on each of the one or more devices that include one or more components of system 400, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 400 and components thereof may be implemented using a computer system such as that described below in relation to FIGS. 5 and 6.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to convert text to speech and/or edit speech on a portable audio device according to various embodiments of the invention. Further, the software design system may be located on a single computer or may be distributed among a plurality of computers attached by a communications network.

A general-purpose computer system according to one embodiment of the invention is configured to perform convert text to speech and/or edit speech on a portable audio device. It should be appreciated that the system may perform other functions and the invention is not limited to having any particular function or set of functions.

For example, various aspects of the invention may be implemented as specialized software executing in a general-purpose computer system 500 such as that shown in FIG. 5. The computer system 500 may include a processor 503 connected to one or more memory devices 504, such as a disk drive, memory, or other device for storing data. Memory 504 is typically used for storing programs and data during operation of the computer system 500. Components of computer system 500 may be coupled by an interconnection mechanism 505, which may include one or more busses (e.g., between components that are integrated within a same machine) and/or a network (e.g., between components that reside on separate discrete machines). The interconnection mechanism 505 enables communications (e.g., data, instructions) to be exchanged between system components of system 500. Computer system 500 also includes one or more input devices 502, for example, a keyboard, mouse, trackball, microphone, touch screen, and one or more output devices 501, for example, a printing device, display screen, speaker. In addition, computer system 500 may contain one or more interfaces (not shown) that connect computer system 500 to a communication network (in addition or as an alternative to the interconnection mechanism 505.

The storage system 506, shown in greater detail in FIG. 6, typically includes a computer readable and writeable nonvolatile recording medium 601 in which signals are stored that define a program to be executed by the processor or information stored on or in the medium 601 to be processed by the program. The medium may, for example, be a disk or flash memory. Typically, in operation, the processor causes data to be read from the nonvolatile recording medium 601 into another memory 602 that allows for faster access to the information by the processor than does the medium 601. This memory 502 is typically a volatile, random access memory such as a dynamic random access memory (DRAM) or static memory (SRAM). It may be located in storage system 506, as shown, or in memory system 504, not shown. The processor 503 generally manipulates the data within the integrated circuit memory 504, 602 and then copies the data to the medium 601 after processing is completed. A variety of mechanisms are known for managing data movement between the medium 601 and the integrated circuit memory element 504, 602, and the invention is not limited thereto. The invention is not limited to a particular memory system 504 or storage system 506.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 500 is shown by way of example as one type of computer system upon which various aspects of the invention may be practiced, it should be appreciated that aspects of the invention are not limited to being implemented on the computer system as shown in FIG. 5. Various aspects of the invention may be practiced on one or more computers having a different architecture or components that that shown in FIG. 5.

Computer system 500 may be a general-purpose computer system that is programmable using a high-level computer programming language. Computer system 500 may be also implemented using specially programmed, special purpose hardware. In computer system 500, processor 503 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of capturing an amount of effort expended in working on a document, the method comprising acts of:
(A) determining one or more periods of time during which a window in which the document is displayed on a user interface display is an active window on the user interface display and the document is an active document in the active window; and
(B) determining a total amount of time expended in working on the document based, at least in part, on the determined one or more periods.

2. The method of claim 1, further comprising an act of:
(C) for the one or more periods of time, determining one or more temporal intervals during which it is inferred that effort was not being expended on the document,
wherein the act (B) includes determining the total amount of time expended based, at least in part, on the determined one or more periods.

3. The method of claim 1, further comprising an act of:
(C) generating an effort report including an indication corresponding to the determined total amount of time expended.

4. The method of claim 3, further comprising an act of:
(D) determining which portions of content were originally created in the document and/or which portions were not originally created,
wherein the act (C) comprises including in the effort report an indication corresponding to an amount of the content that was originally created in the document and/or an indication corresponding to an amount of the content that was not originally created in the document.

5. The method of claim 3, further comprising an act of:
(D) recording a number of keystrokes made in working on the document,
wherein the act (C) comprises including in the effort report an indication corresponding to the number of keystrokes.

6. The method of claim 3, further comprising an act of:
(D) recording a number of copies of the document printed,
wherein the act (C) comprises including in the effort report an indication corresponding to the number of copies.

7. The method of claim 1, wherein the act (A) comprises determining, for each of a plurality of users, one or more periods of time during which a window in which the document is displayed is an active window on the user interface display for the user and the document is an active document in the active window; and
(B) determining, for each user, a total amount of time expended in working on the document by the user, based, at least in part, on the one or more periods determined for the user.

8. A system for capturing an amount of effort expended in working on a document, the system comprising:
an effort capturing module to determine one or more periods of time during which a window in which the document is displayed on a user interface display is an active window and the document is an active document in the active window, to determine a total amount of time expended in working on the document based, at least in part, on the determined one or more periods.

9. The system of claim 8, wherein the effort capturing module is further operative to determine, for the one or more periods of time, one or more temporal intervals during which it is inferred that effort was not being expended on the document, and to determine the total amount of time expended based, at least in part, on the determined one or more periods.

10. The system of claim 8, further comprising:
a report generating module to generate an effort report including an indication corresponding to the determined total amount of time expended.

11. The system of claim 10, wherein the effort capturing module is operative to determine which portions of content were originally created in the document and/or which portions were not originally created, and
wherein the report generating module is operative to include in the effort report an indication corresponding to an amount of the content that was originally created in the document and/or an indication corresponding to an amount of the content that was not originally created in the document.

12. The system of claim 10, wherein the effort capturing module is operative to record a number of keystrokes made in working on the document, and
wherein the report generating module is operative to include in the effort report an indication corresponding to the number of keystrokes.

13. The system of claim 8, wherein the effort capturing module is operative to determine, for each of a plurality of users, one or more periods of time during which a window in which the document is displayed is an active window on the user interface display for the user and the document is an active document in the active window, and
wherein the report generating module is operative to determine, for each user, a total amount of time expended in working on the document by the user, based, at least in part, on the one or more periods determined for the user.

14. A method of capturing an amount of effort expended in working on a document, the method comprising acts of:
(A) determining one or more periods of time during which a window in which the document is displayed is a most forward window on a user interface display and the document is an active document in the most forward window;
(B) determining a total amount of time expended in working on the document based, at least in part, on the determined one or more periods.

15. The method of claim 14, further comprising an act of:
(C) for the one or more periods of time, determining one or more temporal intervals during which it is inferred that effort was not being expended on the document,
wherein the act (B) includes determining the total amount of time expended based, at least in part, on the determined one or more periods.

16. The method of claim 14, further comprising an act of:
(C) generating an effort report including an indication corresponding to the determined total amount of time expended.

17. The method of claim 16, further comprising an act of:
(D) determining which portions of content were originally created in the document and/or which portions were not originally created,
wherein the act (C) comprises including in the effort report an indication corresponding to an amount of the content that was originally created in the document and/or an indication corresponding to an amount of the content that was not originally created in the document.

18. The method of claim 16, further comprising an act of:
(D) recording a number of keystrokes made in working on the document,
wherein the act (C) comprises including in the effort report an indication corresponding to the number of keystrokes.

19. The method of claim 16, further comprising an act of:
(D) recording a number of copies of the document printed,
wherein the act (C) comprises including in the effort report an indication corresponding to the number of copies.

20. The method of claim 14, wherein the act (A) comprises determining, for each of a plurality of users, one or more periods of time during which a window in which the document is displayed is a most forward window on the user interface display for the user and the document is an active document in the most forward window; and
(B) determining, for each user, a total amount of time expended in working on the document by the user, based, at least in part, on the one or more periods determined for the user.
